(19) United States
(12) Patent Application Publication
(10) Pub. No.: US 2004/0054772 A1
(43) Pub. Date: Mar. 18, 2004

(54) Apparatus and method for determining network elements having reserved resources for voice traffic

(76) Inventor: Muneyb Minhazuddin, New South Wales (AU)

Correspondence Address: John C. Moran, P.C., 4120 E. 115th Place, Thornton, CO, 80233, US

(21) Appl. No.: 10/232,453

(22) Filed: Aug. 30, 2002

(51) Int. Cl. G06F 15/173; G09G 5/00

(52) U.S. Cl. 709/224; 345/736

(57) ABSTRACT

An apparatus and method that first identifies all of the network elements that are part of a switching network and then removes from this overall network configuration those network elements that are not transporting a predefined type of information. The result is a network configuration that is made up of only those network elements that are switching the predefined type of information. The predefined type of information may be voice or video information or a combination of voice and video information.

### TECHNICAL FIELD

The present invention relates to telecommunication systems and, in particular, to monitoring network elements utilized for the transmission of voice information.

### BACKGROUND OF THE INVENTION

Within the prior art, a well recognized problem in troubleshooting and monitoring packet networks that are transporting voice such as Voice Over IP networks (VoIP) is in identifying which network elements such as routers and switches are actually transporting the VoIP traffic and which of the network elements are simply transporting other types of data. For a large corporation or other institutions that have multiple sites scattered either over a continent or globally, the network that such an entity has for the switching of data is extremely large. However, only a subset of those network elements are actually involved in the transporting of VoIP traffic.

Within the prior art, when field engineers do not have the documentation specifying which network elements are transporting VoIP traffic, the approach that has been utilized by the field engineers is to individually contact each network element to determine if that network element is transporting VoIP traffic between two end points that the field engineer is attempting to trouble shoot. This hit and miss technique is extremely time consuming. However, within the prior art, it has been found necessary to perform since often the initial documentation designating which network elements are transporting VoIP traffic is often not available.

### SUMMARY OF THE INVENTION

The aforementioned problems are solved and a technical advance is achieved in the art by an apparatus and method that first identifies all of the network elements that are part of a switching network and then removes from this overall network configuration those network elements that are not transporting a predefined type of information. The result is a network configuration that is made up of only those network elements that are switching the predefined type of information. The predefined type of information may be voice or video information or a combination of voice and video information.

### BRIEF DESCRIPTION OF THE DRAWING

FIG. 1 illustrates an embodiment of an overall switching network comprising a plurality of network elements;

FIG. 2 illustrates an embodiment of the network elements remaining after the network elements that are switching only data are removed from FIG. 1;

FIG. 3 illustrates, in flowchart form, operations performed by an embodiment of the invention; and

FIG. 4 illustrates, in block diagram form, a maintenance terminal in accordance with an embodiment of the invention.

### DETAILED DESCRIPTION

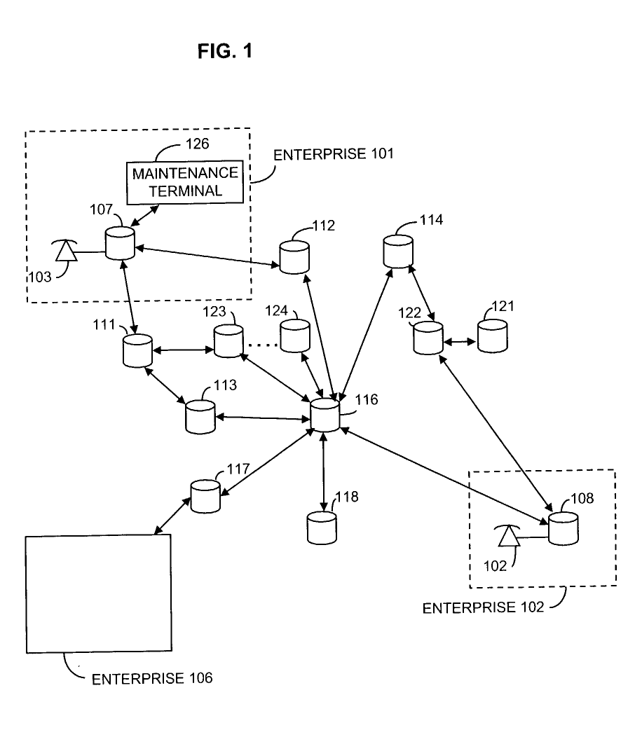

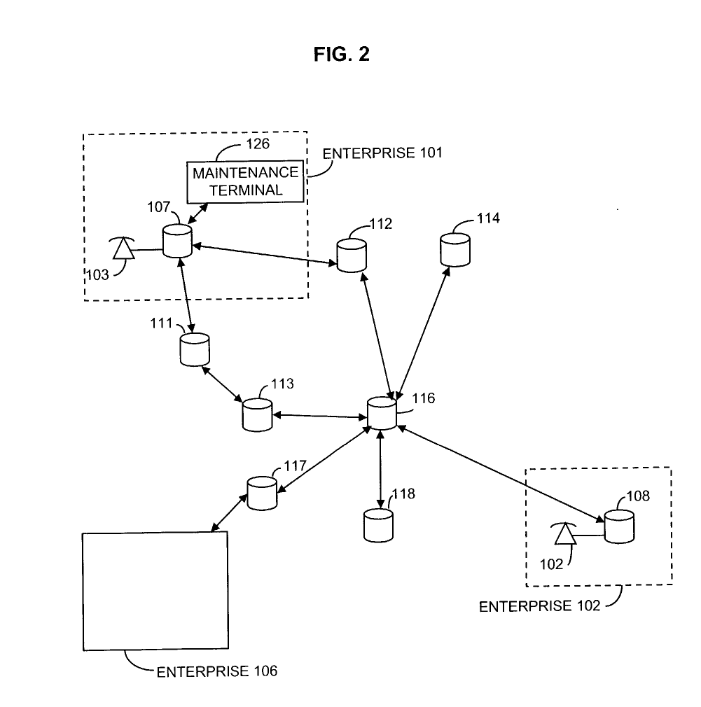

FIG. 1 illustrates a total network topology for a large entity voice and data switching system. For convenience, network elements 107, 108, and 111-119 are those that are designated to transport VoIP traffic. Although this example discusses only voice traffic, one skilled in the art could readily envision how to apply this example to video traffic or a combination of video and voice traffic. FIG. 2 illustrates in accordance with one embodiment of the invention the resulting network topology that remains for display purposes after all network elements that are transporting only data are removed from the network topology of FIG. 1. The removed network elements are not physically removed from the network.

In order to transport VoIP traffic through network elements, it is desirable to prioritize the real time traffic such as the VoIP traffic over the regular data traffic. The Internet Engineering Task Force has established the Resource Reservation Setup Protocol (RSVP) which is specification RFC 2205. RSVP is the quality of service mechanism commonly chosen for utilization within an office environment (one office building) to handle real time traffic such as VoIP traffic. Associated with the RSVP protocol is a Management Information Base (specification RSVP MIB RFC 2206). The MIB can be interrogated by the utilization of Simple Network Management Protocol (SNMP) inquiry messages to determine details of reserved flow parameters. The MIB variables provide the complete flow specification information for every traffic flow. Because of the large amount of data that is required for the RSVP MIB, the Internet Engineering Task Force has also defined the Differentiated Services Framework (DIFFSERV) specification RFC 2475. The DIFFSERV also allows for the prioritization of real time traffic such as VoIP traffic over other data types. Normally, the DIFFSERV protocol is used within the core of the network topology; whereas, the RSVP is used on the edges within individual enterprise sites. When a network is initially setup to handle VoIP traffic, a subset of the network elements are chosen by utilizing either RSVP or DIFFSERV protocol to handle the VoIP traffic. Unfortunately, often when a field services person must work on the network the initial information defining what network elements were defined to handle VoIP traffic is not available.

One skilled in the art could readily envision protocol other than RSVP and DIFFSERV that could be used to prioritize VoIP traffic over data traffic in the network elements.

One embodiment of the invention determines the network elements that are designated to handle VoIP traffic by interrogating each network element within the network topology to determine whether each of these network elements is implementing the RSVP or DIFFSERV protocol using SNMP messages.

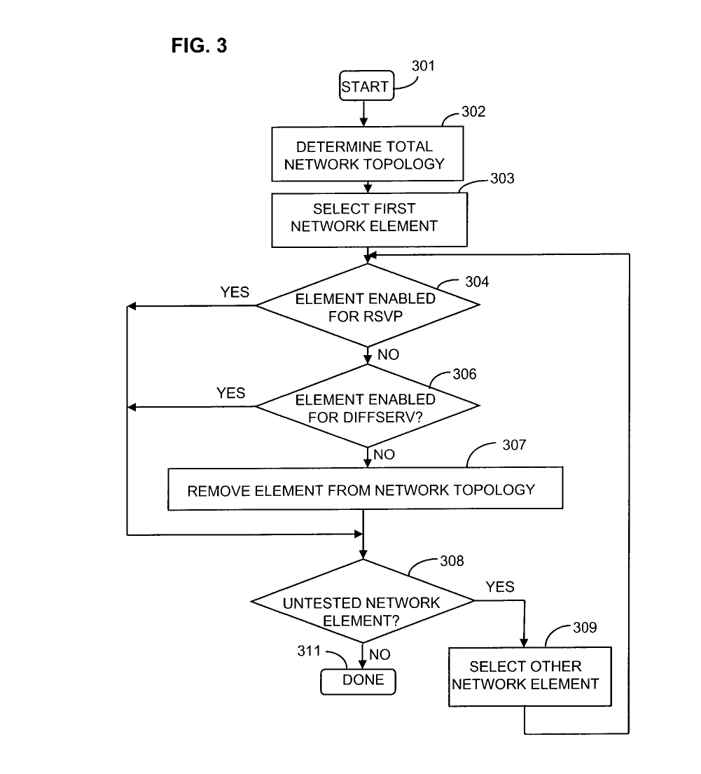

FIG. 3 illustrates, in flowchart form, the operations utilized to implement one embodiment of the invention. One skilled in the art would realize the operations illustrated in FIG. 3 could be performed in other sequences or certain operations could be performed in parallel. Also in one embodiment, maintenance terminal 126 controls the operations of FIG. 3. However, one skilled in the art would readily realize that other computer or hardware systems could be positioned in other parts of the network illustrated in FIGS. 1 and 2 for controlling the operations illustrated by FIG. 3. After being started in block 301, block 302 determines the total network topology which includes not only the network elements within the network but the manner in which these network elements are interconnected. One skilled in the art would readily realize that one approach is simply to interrogate in a fairly random manner each network element illustrated in FIG. 1 to determine how this network element is connected to other network elements. However, such a brute force method requires a great deal of time to accomplish. Advantageously, a faster and more efficient method of determining the network topology such as illustrated in FIG. 1 is set forth in the U.S. patent application entitled “Using Link State Information to Discover IP Network”, Ser. No. 10/127967 filed on Apr. 22, 2002, Attorney Docket No. 401046-A-01-US (Goringe) and U.S. patent application entitled “Topology Discovery by Partitioning Multiple Discovery Techniques”, Ser. No. 10/127888 filed on Apr. 26, 2002, Attorney Docket No. 401059-A-01-US (Goringe). These two patent applications are hereby incorporated herein by reference. Utilizing either the brute force method of the prior art or the method set forth in the two patent applications, block 302 determines the network topology illustrated in FIG. 1. One skilled in the art would readily realize that if other network topologies were being analyzed by the methods utilized in block 302 that other topology illustrations would result.

Once a total network topology is determined such as illustrated in FIG. 1, blocks 303-309 then conceptually remove from this overall network topology all network elements that set up to prioritize real time traffic such as VoIP traffic over other data traffic. The resulting topology that is displayed to the field engineer illustrates only elements 107, 108, and 111-119. Note, that the remaining blocks are not physically removed from the network of FIG. 1. Block 303 selects an element from FIG. 1 such as element 111. Block 304 then determines if this network element is enabled for RSVP by transmission of a SNMP message to network element 111 inquiring whether or not it is set up for the RSVP protocol. If the answer is yes, control is transferred to decision block 308. If the answer in decision block 304 is no, a second SNMP message is transmitted to network element 111 inquiring whether it is setup for the DIFFSERV protocol. In the present example, network element 111 is utilizing either the RSVP or DIFFSERV protocol SO control will be transferred from either decision block 304 or decision block 306 to decision block 308. Decision block 308 determines if there are any remaining untested network elements. Since network element 111 was the first network element tested, the answer in decision block 308 is yes, and control is transferred to block 309 that selects another network element for testing of the network elements of FIG. 1.

For the present example, assume that the other network element is network element 121. Control is transferred from block 309 back to decision block 304. Decision blocks 304 and 306 transmits SNMP messages to network element 129 inquiring whether it is implementing the RSVP or DIFFSERV protocol. Since in the present example the answer is no, control is transferred from decision block 306 to block 307. Utilizing well known graphical techniques to those skilled in the art, block 307 removes network element 129 from the displayed network topology illustrated in FIG. 1. After the network element is removed, block 308 transfers control to block 309 that selects another network element before transferring control back to decision block 304. After it is determined by decision block 308, that all network elements of FIG. 1 have been tested, the process is ended by execution of block 311. The resulting network topology is illustrated in FIG. 1 and contains only those network elements that are implementing either the RSVP protocol or the DIFFSERV protocol.

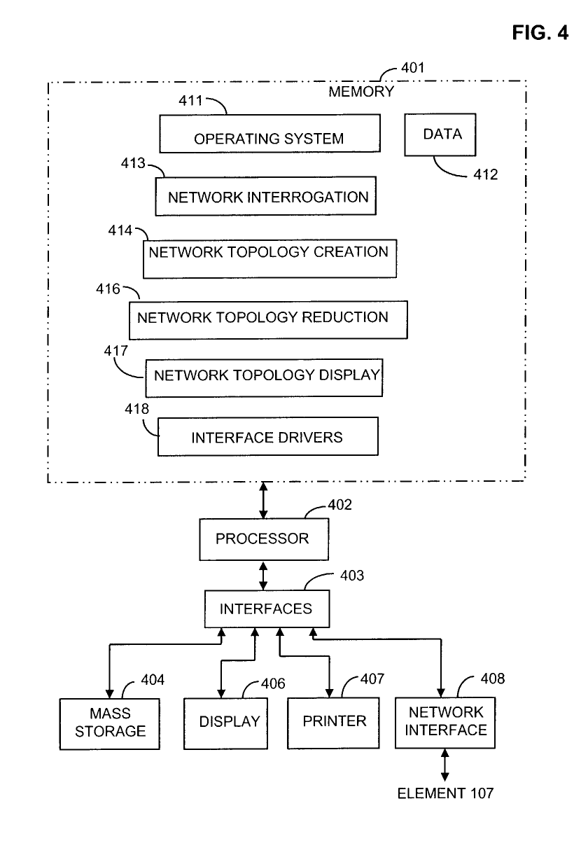

FIG. 4 illustrates, in block diagram form, greater detail of maintenance terminal 126 of FIGS. 1 and 2. Overall control of the maintenance terminal is provided by processor 402 executing instructions from memory 401 and storing and retrieving data within memory 401. Instruction and data may also be stored within mass storage 404. Processor 402 is interconnected to peripheral devices 404-408 via interfaces 403. Display 406 allows processor 401 to display information to a user, and printer 407 allows information to be printed out for the user. Network interface 408 provides the interconnection to switching element 107 of enterprise 101. One skilled in the art would readily realize that maintenance terminal 126 could be connected to any switching element of the network illustrated in FIGS. 1 and 2.

Operating system 411 provides the overall control of the software functions performed by processor 402. Routines 413-417 provide the operations as illustrated in FIG. 3 in accordance with one embodiment of the invention. Interface drivers 418 provide the necessary support for peripheral units. Although not illustrated in FIG. 4, one skilled in the art would readily realize that other routines and applications would be executed by processor 402 for various functions. Network interrogation routine 413 provides the function of interrogating the network elements of the network and determining switching information from these network elements. Network topology creation routine 414 is utilized to create the overall network map such as illustrated in FIG. 1 which may be displayed utilizing network topology display routine 417 on display 406 or printer 407. Network topology reduction routine 416 is utilized to remove from the overall network map those elements that are not performing specified switching functions.

The operations of maintenance terminal 126 can be implemented in software, hardware, or a combination thereof. In the currently contemplated best mode, the operations of maintenance terminal 126 of FIG. 4 are implemented in software, as an executable program, that is executed by processor 402. Processor 402 is a hardware device for executing software, particularly that stored in memory 401. Processor 402 can be any custom made or commercially available processor.

The memory 401 can include any one or combination of volatile memory elements (e.g., random access memory (RAM, such as DRAM, SRAM, SDRAM, etc.) and nonvolatile memory elements (e.g., ROM, hard drive, tape, CDROM, etc.). Moreover, the memory 401 may incorporate electronic, magnetic, optical, and/or other types of storage media. Note that the memory 401 can have a distributed architecture, where various components are situated remote from one another, but can be accessed by processor 402.

When the operations of maintenance terminal 126 are implemented in software, as is shown in FIG. 3, it should be noted that the software can be stored on any computer-readable medium for use by or in connection with any computer related system or method. In the context of this document, a computer-readable medium is an electronic, magnetic, optical, or other physical device or means that can contain or store a computer program for use by or in connection with a computer related system or method. Maintenance terminal 126 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. For example, the computer-readable medium can be, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In an alternative embodiment, where maintenance terminal 126 is implemented in hardware, maintenance terminal 126 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Of course, various changes and modifications to the illustrated embodiments described above will be apparent to those skilled in the art. These changes and modifications can be made without departing from the spirit and scope of the invention and without diminishing its intending advantages. It is therefore intended that such changes and modifications be covered by the following claims except insofar as limited by the prior art.

What is claimed is:

1. A method for monitoring a switching network having a plurality of network elements, comprising the steps of:
interrogating the plurality of network elements to determine a subset of the plurality of network elements transporting voice information;
creating a network topology illustrating all of the plurality of network elements; and
removing all of the plurality of network elements except for the subset of the plurality of network elements from the network topology.

2. The method of claim 1 further comprises the step of displaying the resulting network topology after the step of removing has been performed.

3. The method of claim 1 wherein the step of interrogating comprises the step of determining ones of the plurality of network elements that are enabled for a resource reservation setup protocol.

4. The method of claim 3 wherein the step of interrogating further comprises the step of designating each determined one of the plurality of network elements as one of the subset of the plurality of network elements.

5. The method of claim 1 wherein the step of interrogating comprises the step of determining ones of the plurality of network elements that are enabled for a differentiated services framework protocol.

6. The method of claim 5 wherein the step of interrogating further comprises the step of designating each determined one of the plurality of network elements as one of the subset of the plurality of network elements.

7. The method of claim 1 wherein the step of creating comprises the step of determining interconnection of each of the plurality of network elements within the switching network.

8. A processor-readable medium comprising processor-executable instructions configured for:
interrogating the plurality of network elements to determine a subset of the plurality of network elements transporting voice information;
creating a network topology illustrating all of the plurality of network elements; and
removing all of the plurality of network elements except for the subset of the plurality of network elements from the network topology.

9. The processor-readable medium of claim 8 further comprises displaying the resulting network topology after the step of removing has been performed.

10. The processor-readable medium of claim 8 wherein the interrogating comprises determining ones of the plurality of network elements that are enabled for a resource reservation setup protocol.

11. The processor-readable medium of claim 10 wherein the interrogating further comprises designating each determined one of the plurality of network elements as one of the subset of the plurality of network elements.

12. The processor-readable medium of claim 8 wherein the interrogating comprises determining ones of the plurality of network elements that are enabled for a differentiated services framework protocol.

13. The processor-readable medium of claim 12 wherein the interrogating further comprises designating each determined one of the plurality of network elements as one of the subset of the plurality of network elements.

14. The processor-readable medium of claim 8 wherein the creating comprises determining interconnection of each of the plurality of network elements within the switching network.

15. An apparatus for performing the steps of claim 1.

16. An apparatus for performing the steps of claim 4.

17. An apparatus for performing the steps of claim 6.

18. An apparatus for performing the steps of claim 7.

19. A method for monitoring a switching network having a plurality of network elements, comprising the steps of:
interrogating the plurality of network elements to determine a subset of the plurality of network elements transporting a predefined type of information;
creating a network topology illustrating all of the plurality of network elements; and
removing all of the plurality of network elements except for the subset of the plurality of network elements from the network topology.

20. The method of claim 19 further comprises the step of displaying the resulting network topology after the step of removing has been performed.

21. The method of claim 19 wherein the step of interrogating comprises the step of determining ones of the plurality of network elements that are enabled for a resource reservation setup protocol.

22. The method of claim 21 wherein the step of interrogating further comprises the step of designating each determined one of the plurality of network elements as one of the subset of the plurality of network elements.

23. The method of claim 19 wherein the step of interrogating comprises the step of determining ones of the plurality of network elements that are enabled for a differentiated services framework protocol.

24. The method of claim 23 wherein the step of interrogating further comprises the step of designating each determined one of the plurality of network elements as one of the subset of the plurality of network elements.

25. The method of claim 19 wherein the step of creating comprises the step of determining interconnection of each of the plurality of network elements within the switching network.

26. A processor-readable medium comprising processor-executable instructions configured for:
interrogating the plurality of network elements to determine a subset of the plurality of network elements transporting predefined type of information;
creating a network topology illustrating all of the plurality of network elements; and
removing all of the plurality of network elements except for the subset of the plurality of network elements from the network topology.

27. The processor-readable medium of claim 26 further comprises displaying the resulting network topology after the step of removing has been performed.

28. The processor-readable medium of claim 26 wherein the interrogating comprises determining ones of the plurality of network elements that are enabled for a resource reservation setup protocol.

29. The processor-readable medium of claim 28 wherein the interrogating further comprises designating each determined one of the plurality of network elements as one of the subset of the plurality of network elements.

30. The processor-readable medium of claim 26 wherein the interrogating comprises determining ones of the plurality of network elements that are enabled for a differentiated services framework protocol.

31. The processor-readable medium of claim 30 wherein the interrogating further comprises designating each determined one of the plurality of network elements as one of the subset of the plurality of network elements.

32. The processor-readable medium of claim 26 wherein the creating comprises determining interconnection of each of the plurality of network elements within the switching network.
